(19) United States
(12) Patent Application Publication
(10) Pub. No.: US 2017/0177482 A1
(43) Pub. Date: Jun. 22, 2017

(54) COMPUTING SYSTEM HAVING MULTI-LEVEL SYSTEM MEMORY CAPABLE OF OPERATING IN A SINGLE LEVEL SYSTEM MEMORY MODE

(71) Applicant: Intel Corporation, Santa Clara, CA (US)

(72) Inventor: Daniel GREENSPAN, Jerusalem (IL)

(21) Appl. No.: 14/975,487

(22) Filed: Dec. 18, 2015

(51) Int. Cl. G06F 12/08; G06F 9/44; G06F 3/06

(52) U.S. Cl. CPC G06F 12/0815; G06F 12/0891; G06F 3/0602; G06F 3/0659; G06F 3/0685; G06F 9/4406; G06F 2212/1021; G06F 2212/60; G06F 2212/621

(57) ABSTRACT

An apparatus is described that includes a memory controller to interface to a multi-level system memory having a higher level and a lower level. The memory controller includes register space to indicate first and second modes of operation. In the first mode of operation the higher level is available and the lower level is unavailable. In the second mode of operation the higher level is available and the lower level is available.

### FIELD OF INVENTION

The field of invention pertains generally to the computing sciences, and, more specifically, to a computing system having a multi-level system memory capable of operating in a single level system memory mode.

### BACKGROUND

Computing systems typically include a system memory (or main memory) that contains data and program code of the software code that the system's processor(s) are currently executing. A pertinent issue in many computer systems is the system memory. Here, as is understood in the art, a computing system operates by executing program code stored in system memory. The program code when executed reads and writes data from/to system memory. As such, system memory is heavily utilized with many program code and data reads as well as many data writes over the course of the computing system's operation. Finding ways to improve system memory is therefore a motivation of computing system engineers.

### FIGURES

A better understanding of the present invention can be obtained from the following detailed description in conjunction with the following drawings, in which:

FIG. 1 shows a computing system having a multi-level system memory;

FIG. 2 shows a memory controller capable of supporting both 1LM and 2LM modes of operation;

FIG. 3 shows a method that can be performed with the memory controller of FIG. 2;

FIG. 4 shows a computing system.

### DETAILED DESCRIPTION

### 1.0 Multi-Level System Memory

1.a. Multi-Level System Memory Overview

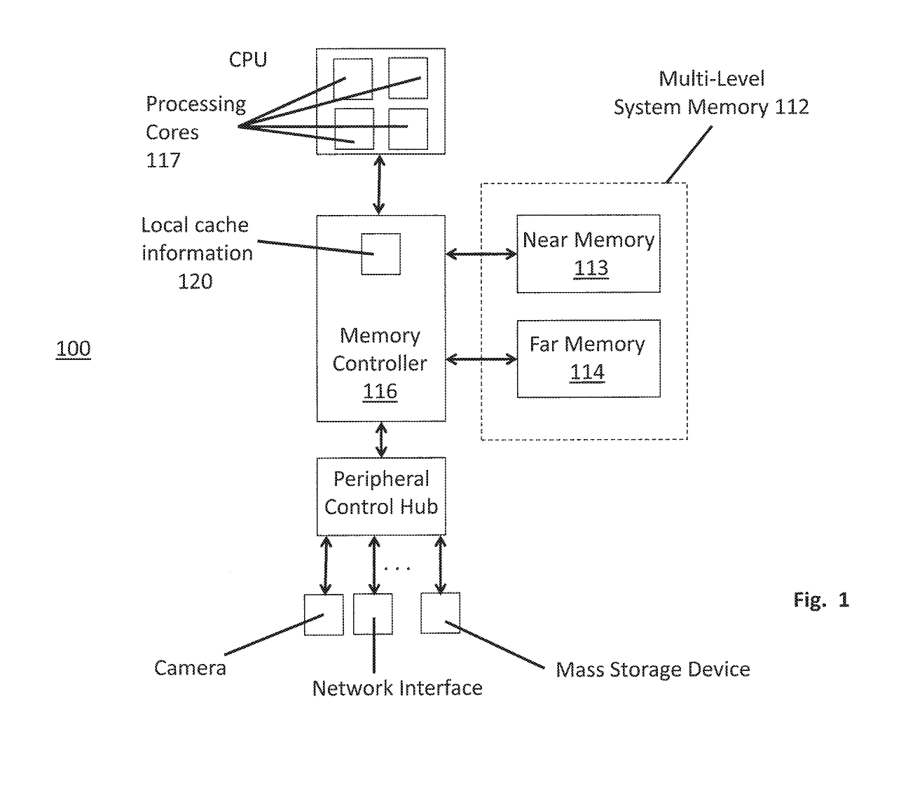

One of the ways to improve system memory performance is to have a multi-level system memory. FIG. 1 shows an embodiment of a computing system 100 having a multi-tiered or multi-level system memory 112. According to various embodiments, a smaller, faster near memory 113 may be utilized as a cache for a larger far memory 114.

The use of cache memories for computing systems is well-known. In the case where near memory 113 is used as a cache, near memory 113 is used to store an additional copy of those data items in far memory 114 that are expected to be more frequently called upon by the computing system. The near memory cache 113 has lower access times than the lower tiered far memory 114 region. By storing the more frequently called upon items in near memory 113, the system memory 112 will be observed as faster because the system will often read items that are being stored in faster near memory 113. For an implementation using a write-back technique, the copy of data items in near memory 113 may contain data that has been updated by the CPU, and is thus more up-to-date than the data in far memory 114. The process of writing back ‘dirty’ cache entries to far memory 114 ensures that such changes are not lost.

According to some embodiments, for example, the near memory 113 exhibits reduced access times by having a faster clock speed than the far memory 114. Here, the near memory 113 may be a faster, volatile system memory technology (e.g., high performance dynamic random access memory (DRAM)) and/or SRAM memory cells co-located with the memory controller 116. By contrast, far memory 114 may be either a volatile memory technology implemented with a slower clock speed (e.g., a DRAM component that receives a slower clock) or, e.g., a non volatile memory technology that may be slower than volatile/DRAM memory or whatever technology is used for near memory.

For example, far memory 114 may be comprised of an emerging non volatile random access memory technology such as, to name a few possibilities, a phase change based memory, three dimensional crosspoint memory device, or other byte addressable nonvolatile memory devices, memory devices that use chalcogenide phase change material (e.g., glass), single or multiple level NAND flash memory, multi-threshold level NAND flash memory, NOR flash memory, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc.

Such emerging non volatile random access memory technologies typically have some combination of the following: 1) higher storage densities than DRAM (e.g., by being constructed in three-dimensional (3D) circuit structures (e.g., a crosspoint 3D circuit structure)); 2) lower power consumption densities than DRAM (e.g., because they do not need refreshing); and/or, 3) access latency that is slower than DRAM yet still faster than traditional non-volatile memory technologies such as FLASH. The latter characteristic in particular permits various emerging non volatile memory technologies to be used in a main system memory role rather than a traditional mass storage role (which is the traditional architectural location of non volatile storage).

Regardless of whether far memory 114 is composed of a volatile or non volatile memory technology, in various embodiments far memory 114 acts as a true system memory in that it supports finer grained data accesses (e.g., cache lines) rather than larger sector based accesses associated with traditional, non volatile mass storage (e.g., solid state drive (SSD), hard disk drive (HDD)), and/or, otherwise acts as an (e.g., byte) addressable memory that the program code being executed by processor(s) of the CPU operate out of. However, far memory 114 may be inefficient when accessed for a small number of consecutive bytes (e.g., less than 128 bytes) of data, the effect of which may be mitigated by the presence of near memory 113 operating as cache which is able to efficiently handle such requests.

Because near memory 113 acts as a cache, near memory 113 may not have formal addressing space. Rather, in some cases, far memory 114 defines the individually addressable memory space of the computing system's main memory. In various embodiments near memory 113 acts as a cache for far memory 114 rather than acting a last level CPU cache. Generally, a CPU cache is optimized for servicing CPU transactions, and will add significant penalties (such as cache snoop overhead and cache eviction flows in the case of hit) to other memory users such as DMA-capable devices in a Peripheral Control Hub. By contrast, a memory side cache is designed to handle all accesses directed to system memory, irrespective of whether they arrive from the CPU, from the Peripheral Control Hub, or from some other device such as display controller.

For example, in various embodiments, system memory is implemented with dual in-line memory module (DIMM) cards where a single DIMM card has both DRAM and (e.g., emerging) non volatile memory chips disposed in it. The DRAM chips effectively act as an on board cache for the non volatile memory chips on the DIMM card. Ideally, the more frequently accessed cache lines of any particular DIMM card will be accessed from that DIMM card's DRAM chips rather than its non volatile memory chips. Given that multiple DIMM cards may be plugged into a working computing system and each DIMM card is only given a section of the system memory addresses made available to the processing cores 117 of the semiconductor chip that the DIMM cards are coupled to, the DRAM chips are acting as a cache for the non volatile memory that they share a DIMM card with rather than a last level CPU cache.

In other configurations DIMM cards having only DRAM chips may be plugged into a same system memory channel (e.g., a DDR channel) with DIMM cards having only non volatile system memory chips. Ideally, the more frequently used cache lines of the channel will be found in the DRAM DIMM cards rather than the non volatile memory DIMM cards. Thus, again, because there are typically multiple memory channels coupled to a same semiconductor chip having multiple processing cores, the DRAM chips are acting as a cache for the non volatile memory chips that they share a same channel with rather than as a last level CPU cache.

In yet other possible configurations or implementations, a DRAM device on a DIMM card can act as a memory side cache for a non volatile memory chip that resides on a different DIMM and is plugged into a different channel than the DIMM having the DRAM device. Although the DRAM device may potentially service the entire system memory address space, entries into the DRAM device are based in part from reads performed on the non volatile memory devices and not just evictions from the last level CPU cache. As such the DRAM device can still be characterized as a memory side cache.

In another possibly configuration, a memory device such as a DRAM device functioning as near memory 113 may be assembled together with the memory controller 116 and processing cores 117 onto a single semiconductor device or within a same semiconductor package. Far memory 114 may be formed by other devices, such as slower DRAM or non-volatile memory and may be attached to, or integrated in that device.

As described at length above, near memory 113 may act as a cache for far memory 114. In various embodiments, the memory controller 116 may include local cache information (hereafter referred to as “Metadata”) 120 so that the memory controller 116 can determine whether a cache hit or cache miss has occurred in near memory 113 for any incoming memory request.

In the case of an incoming write request, if there is a cache hit, the memory controller 116 writes the data (e.g., a 64-byte CPU cache line) associated with the request directly over the cached version in near memory 113. Likewise, in the case of a cache miss, in an embodiment, the memory controller 116 also writes the data associated with the request into near memory 113, potentially first having fetched from far memory 114 any missing parts of the data required to make up the minimum size of data that can be marked in Metadata as being valid in near memory 113, in a technique known as ‘underfill’. However, if the entry in the near memory cache 113 that the content is to be written into has been allocated to a different system memory address and contains newer data than held in far memory 114 (ie. it is dirty), the data occupying the entry must be evicted from near memory 113 and written into far memory 114.

In the case of an incoming read request, if there is a cache hit, the memory controller 116 responds to the request by reading the version of the cache line from near memory 113 and providing it to the requestor. By contrast, if there is a cache miss, the memory controller 116 reads the requested cache line from far memory 114 and not only provides the cache line to the requestor but also writes another copy of the cache line into near memory 113. In many cases, the amount of data requested from far memory 114 and the amount of data written to near memory 113 will be larger than that requested by the incoming read request. Using a larger data size from far memory or to near memory increases the probability of a cache hit for a subsequent transaction to a nearby memory location.

In general, cache lines may be written to and/or read from near memory and/or far memory at different levels of granularity (e.g., writes and/or reads only occur at cache line granularity (and, e.g., byte addressability for writes/or reads is handled internally within the memory controller), byte granularity (e.g., true byte addressability in which the memory controller writes and/or reads only an identified one or more bytes within a cache line), or granularities in between.) Additionally, note that the size of the cache line maintained within near memory and/or far memory may be larger than the cache line size maintained by CPU level caches.

Different types of near memory caching implementation possibilities exist. The sub-sections below describe exemplary implementation details for two of the primary types of cache architecture options: direct mapped and set associative. Additionally, other aspects of possible memory controller 116 behavior are also described in the immediately following sub-sections.

1.b. Direct Mapped Near Memory Cache

In a first caching approach, referred to as direct mapped, the memory controller 116 includes logic circuitry to map system addresses to cache line slots in near memory address space based on a portion of the system memory address. For example, in an embodiment where the size of near memory 113 corresponds to 16,777,216 cache line slots per memory channel, which in turn corresponds to a 24 bit near memory address size (i.e., 2²⁴=16,777,216) per memory channel, 24 upper ordered bits of a request's system memory address are used to identify which near memory cache line slot the request should map to on a particular memory channel (the lower ordered bits specify the memory channel). For instance, bits A[5:0] of system memory address A identify which memory channel is to be accessed and bits A[29:6] of the system memory address identify which of 16,777,216 cache line slots on that channel the address will map to.

Additionally, upper ordered bits that are contiguous with the cache slot identification bits are recognized as a tag data structure used for identifying cache hits and cache misses. Here, different tags for a same set of bits A[29:6] will map to a same cache line slot. For instance, in an embodiment, the next group of four upper ordered bits A[33:30] are recognized as a tag structure used to define 16 unique cache line addresses that map to a particular cache line slot.

The local cache information 120 therefore identifies which tag is currently being stored in each of the near memory cache line slots. Thus, when the memory controller 116 receives a memory write request, the memory controller maps bits A[29:6] to a particular slot in its local cache information 120. A cache hit results if the tag that is kept in local information 120 for the cache line slot that the request address maps to matches the tag of the request address (i.e., the cache line kept in near memory for this slot has the same system memory address as the request). Otherwise a cache miss has occurred. When the memory controller 116 writes a cache line to near memory after a cache miss, the memory controller stores the tag of the address for the new cache line being written into near memory into its local cache information for the slot so that it can test for a cache hit/miss the next time a request is received for an address that maps to the slot.

The local cache information 120 also includes a dirty bit for each cache line slot that indicates whether the cached version of the cache line in near memory 113 is the only copy of the most up to date data for the cache line. For example, in the case of a cache hit for a memory write request, the direct overwrite of the new data over the cached data without a write-through to far memory 114 will cause the dirty bit to be set for the cache line slot. Cache lines that are evicted from near memory 113 cache that have their dirty bit set are written back to far memory 114 but those that do not have their dirty bit set are not written back to far memory 114.

A valid data bit may also be kept for each cache line slot to indicate whether the version of the cache line kept in the near memory cache line slot is valid. Certain operational circumstances may result in a cache line in near memory being declared invalid. The memory controller is free to directly overwrite the cache line in near memory that is marked invalid even if the cache line overwriting it has a different tag. Generally, when a cache line is called up from far memory 114 and written into near memory 113 its valid bit is set (to indicate the cache line is valid).

1.c. Set Associative Near Memory Cache

In another approach, referred to as set associative, the memory controller includes hashing logic that performs a hash operation on the system memory address of an incoming system memory access request. The output of the hashing operation points to a “set” of entries in near memory cache where the cache line having the system memory address can be stored in the cache. In this approach, the memory controller keeps in its local cache information 120 a local set cache record that identifies, for each set of the cache, which system memory addresses are currently stored in the respective set and whether the set is full.

The local keeping of the system memory addresses permits the memory controller 116 to locally identify cache hits/misses internally to the memory controller 116. Locally tracking which sets are full also identifies to the memory controller 116 when a cache eviction is necessary. For instance, if a new memory request is received for a cache line whose system memory address maps to a set that is currently full, the memory controller will write the cache line associated with the newly received request into the set and evict one of the cache lines that is resident according to some eviction policy (e.g., least recently used, least frequently used, etc.). The memory controller may also locally keep meta data in the local cache information 120 that tracks the information needed to implement the eviction policy.

When a cache miss occurs for a write request that maps to a full set, the new cache line associated with the request is written into near memory cache and a cache line that is resident in the set is evicted to far memory if it is dirty. When a cache miss occurs for a read request that maps to a full set, the requested cache line associated with the request is read from far memory and written into near memory cache. A cache line that is resident in the set is evicted to far memory if it is dirty. Dirty bits and valid bits can also be kept for each cached cache line and used as described above.

1.d. Other Caches

As alluded to above other types of caching schemes may be applied for near memory. One possible alternative approach is where near memory is implemented as a fully associative cache. In this case, the cache is viewed as one large set that all system memory address map to. With this qualification, operations are the same/similar to those described just above. Additionally, rather than act as a memory side cache, near memory may instead be implemented as a last level CPU cache.

1.e. Near Memory Cache Scrubbing

At various ensuing intervals, the memory controller may scroll through its local cache information 120 and write a copy of those of the cache lines in near memory cache 113 whose corresponding dirty bit is set. The “scrubbing” of the dirty near memory content back to far memory results in far memory increasing its percentage of the most recent data for the system's corresponding cache lines. As part of the scrubbing process, any cache line in near memory having a copy written back to far memory has its dirty bit cleared in the local cache information.

### 2.0 Using Near Memory as System Memory in a 1LM Mode

2.a. Background: 2LM vs. 1LM

A multi-level system memory may be described as a “2LM” system (two-level-memory) whereas a traditional single level system memory may be described as a “1LM” system (one-level-memory).

A computing system that has 2LM capability may occasionally need to operate in a 1LM mode where far memory 114 is unavailable for use. One situation where far memory 114 may be unavailable for use may be initial system boot-up. Another situation is where connectivity to the far memory 114 has failed (for example, due to bad connection with the memory controller 116). In the case of the former (system boot-up), far memory 114 needs to be provisioned or otherwise prepared for use before it can actually be used. In the case of the latter (far memory connection failure), or other failures of the far memory itself, far memory 114 may be unusable for an extended period of time.

Unfortunately a 2LM system can not simply or naturally operate as a 1LM system. For instance, to the extent the system is attempting to operate and execute program code in a 1LM mode, the program code and the data it refers to cannot readily be stored in near memory 113 because near memory 113 nominally operates as a cache. As such, the memory controller 116 is designed on the basis that it can write data to far memory 114 in the case of a write operation that experiences a near memory cache miss, and additionally on the basis that it may evict dirty cache data from near memory 113 to far memory 114 to allow a cache entry to be re-allocated to a different address. Additionally, data will be called up from far memory 114 in the case of a read operation that experiences a near memory cache miss. Because far memory 114 is not available in a 1LM mode, these operations cannot be performed. Thus, according to the nominal design/operation of the memory controller 116, near memory 113 is not readily available for use as main memory in a 1LM mode.

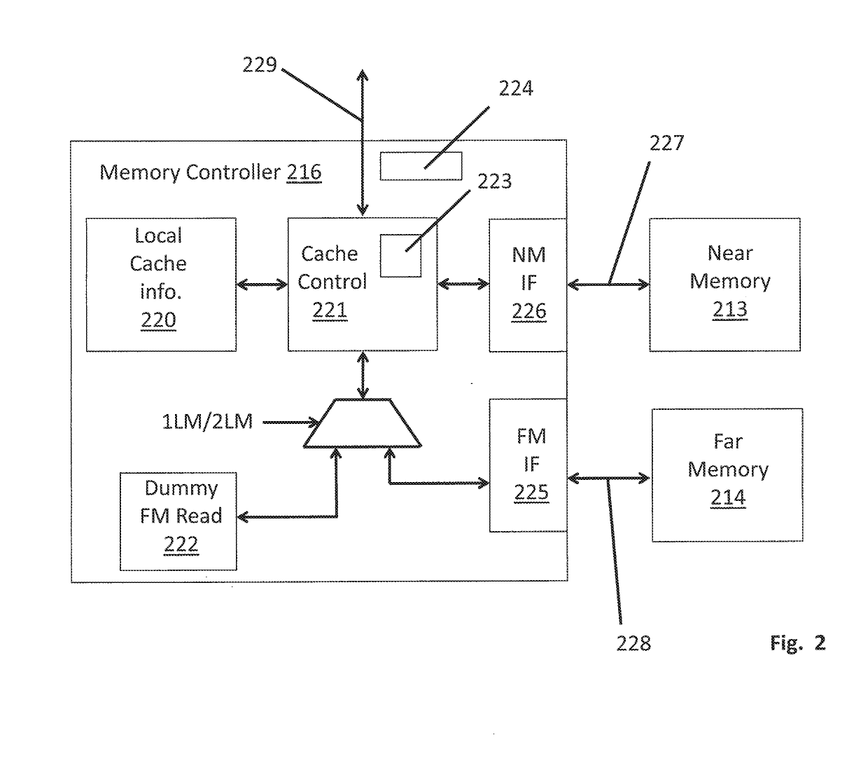

FIG. 2 shows an improved 2LM memory controller 216 that is specially designed to permit near memory 213 to be used as a system memory in a 1LM mode and to switch from 1LM mode to 2LM mode without disruption of memory consistency. Here, as described in more detail below, in 1LM mode the memory controller 216 understands that far memory 214 is unavailable and therefore does not support nominal operations that write to or read from far memory 214.

2.b. Limited 1LM System Memory Address Range

In an embodiment, in order to support the memory controller's ability to treat near memory 213 as system memory in a 1LM mode, the size of the program code that the system executes in 1LM mode and the data it refers to is not permitted to exceed the size of the physical near memory resources 213. With this environmental rule, the system is able to execute out of near memory 213 without invoking far memory 214. As such, the system can operate from near memory 214 in 1LM mode.

For example, recall from the direct mapped cache discussion above in which a first lower order portion of a system memory address (e.g., bits A[29:6]) is used to identify which near memory slot the address maps to and a contiguous group of upper tag bits of the system memory address (e.g., bits A[33:30]) are used to identify cache hits or cache misses. In an embodiment, system program code for execution in 1LM mode is structured such that only one tag is permitted for any unique combination of bits A[29:6]. For example, only bit pattern “0000” is permitted for bits A[33:30] of any system memory address.

By structuring the code to use system memory addresses that only refer to one tag per near memory cache line slot, the code is essentially structured so that once these addresses are present in the near memory cache (discussed further below), there will be no further cache misses at near memory. With the program code referring to system memory addresses that are structured to result in a near memory cache hit, operations to far memory will generally be avoided and the system can operate out of near memory cache as if it were normal system memory and not a memory side cache. Correspondingly, by limiting the code to only one tag value per cache line slot, the range of system memory addresses are limited to the size of the near memory itself (the existence of multiple tag values effectively permits the cache to support an address range that is larger than the physical size of the cache).

The same applies in the case of a set associative cache, the size of available system memory addresses in 1LM mode may again be limited so that each set in the near memory cache will have a number of system memory addresses that map to it that are not greater than the size of the set. For example, if each set holds 8 entries, each with a different tag then, the system memory address range is limited so that it can be encompassed using the 8 tags of each set in the near memory cache. As such, like the direct mapped approach described just above, misses in near memory cache will be avoided, which permits the system to operate out of near memory as if it were system memory and not a memory side cache.

Hashing functions may naturally support the above described set associative approach. For example, if near memory 213 were implemented along any particular memory channel as a set associative cache having 2,097,152 sets and 8 entries per set, a contiguous 24 bit system memory address range can hash so as to fill all entries of the cache without conflict. Thus, by keeping the size of the system memory address used during 1LM mode limited, the system can avoid near memory cache evictions and operate out of near memory cache as if it were a system memory.

2.c. Dummy Far Memory Reads

Although the above discussion has emphasized the avoidance of reads or writes to/from far memory 214 once the addresses are held in the near memory 213, there also exists the issue of the initial case in which the near memory cache is empty and therefore all accesses may be expected to result in a far memory read (including cases where writes to memory result in a read from far memory to underfill the data stored for the write in near memory).

One approach may be to initialize the cache Metadata 220 such that it appears that the cache initially holds a valid copy of all far memory (FM) data for the given address range. A simpler approach is shown whereby a dummy FM value is provided in place of an actual access through the FM interface 225 when operating in the 1LM mode. As such, the memory controller 216 is designed to provide a made-up or “dummy” value as data from far memory if a read of far memory actually occurs within a 1LM mode. As observed in FIG. 2, the memory controller 216 includes dummy far memory read logic 222 that becomes enabled once the memory controller is entered into a 1LM mode. Here, any far memory read instead of being directed to the actual far memory interface 225 is instead directed to the dummy far memory read logic 222. The dummy far memory read logic 222 in response provides a dummy far memory read value (e.g., a cache line full of 0s).

2.d. Raise of Error Flag in Case of Near Memory Cache Miss

With the above discussions emphasizing that the memory address range to be utilized in a 1LM mode should be limited so as to avoid near memory cache misses. In an embodiment, the improved memory controller of FIG. 2 is configured with logic circuitry 223 that is designed to recognize when the memory controller is operating in 1LM mode and to recognize if a cache miss has occurred in the 1LM mode that requires dirty cache data to be evicted to far memory 214. If both conditions are met, the logic circuitry raises a fatal error flag. The ability to recognize that the memory controller 216 is operating in a 1LM mode can be established with configuration register space 224 of the memory controller 216 that specifies whether the memory controller is to operate in a 1LM or 2LM mode. If the 1LM mode is set in the configuration register space, the memory controller will automatically implement 1LM operating mode procedures (e.g., raise of error flag if near memory cache miss requiring dirty eviction, read of far memory dummy value, suspension of scrubbing (described below), etc.).

2.e Suspension of Scrubbing

Besides operating with code that is deliberately structured to avoid near memory cache misses, when operating in a 1LM mode, in an embodiment the memory controller 216 is designed to suspend scrubbing operations so as to avoid writes to far memory. Here, recall that during normal operation the memory controller 216 will scrub its local cache information 220 and write copies back to far memory 214 for those cache lines having a set dirty bit. In 1LM mode, because access to far memory is to be avoided, the scrubbing process is not performed. As such any logic circuitry that is designed to perform the scrubbing is deactivated if the register space 224 indicates that the memory controller is in a 1LM mode.

As a consequence of the suspended scrubbing operations during the 1LM mode, the system operates with potentially large numbers of cache lines in near memory 213 having their associated dirty bit set in the local cache information 220. That is, the local cache information 220 may have a large percentage of dirty entries not only because scrubbing activity is suspended but also because write requests to system memory should result in a cache hit (as a consequence of the limited system memory address range) which, in turn, causes a write to near memory 213 and the setting of the dirty bit in a corresponding local cache information 220 entry.

2.f. Dirty Marking

Irrespective of whether the problem of initial cache misses is addressed by serving cache misses using the dummy FM value, or by pre-loading the Metadata 220, care must be taken such that data read from the memory controller will remain consistent—even if not written to the far memory 214 after the switch from 1LM mode to 2LM mode. This may be achieved either by ensuring that the data provided by the dummy FM read 222 matches known initial values of far memory (e.g., all zeros), or, where the Metadata is preloaded, by ensuring that the initial values of near memory 213 matches known initial values of far memory (e.g., all zeros).

In many embodiments, it may be problematic or inefficient to ensure the consistency in this manner, and an alternative approach may be taken as follows: when in 1LM mode, any read accesses—whether served by the dummy FM read 222 or by a cache hit due to Metadata 220 preload, will result in the data access being marked as dirty (as if it had been written to), even though it may never be written to. Marking the data dirty as such ensures that when 2LM mode is engaged, the data as seen by the CPU will be written to far memory 214, and as such, should it be evicted from cache then re-read, the data read from far memory 214 will be consistent with what was initially read from dummy FM 222 or near memory 213.

2.q Transition from 1LM Mode to 2LM Mode

Here, upon leaving a 1LM mode and entering a 2LM mode, the memory controller 216 will no longer be redirected to dummy far memory 222 and instead will begin accessing far memory 214. Data consistency from the 1LM mode to the 2LM mode, is preserved due to any data that was written by the CPU having been marked as ‘dirty’ in near memory 213, and due to the synchronization mechanism for read data described above in subsections 2.c (“Dummy Far Memory Reads”) and 2.g (“Dirty Marking”). Any valid data value of the 1LM mode should not be prohibited from being written back to far memory 214 upon entrance into the 2LM mode. As such, in the case where a data value is read from the dummy logic 222 during 1LM mode and not written to again during 1LM mode, the setting of the dirty bit will cause the data value to be written back to far memory 214 in 2LM mode where a cache miss causes eviction of the data value from near memory 213 into far memory 214.

The setting of the dirty bit for dummy values as described just above may be dropped in embodiments where far memory 214 is known to return a same dummy value upon a read from a memory location that has not yet been written to.

In same or alternative embodiments, the 1LM dummy read circuitry 222 may provide something other than only dummy read data. For example, one or more system memory addresses may be hard coded by the dummy read return logic 222 to return substantive meaningful data, such as a hardware version identifier, or a counter value indicating how many times the dummy read data has been accessed, and not just meaningless dummy data.

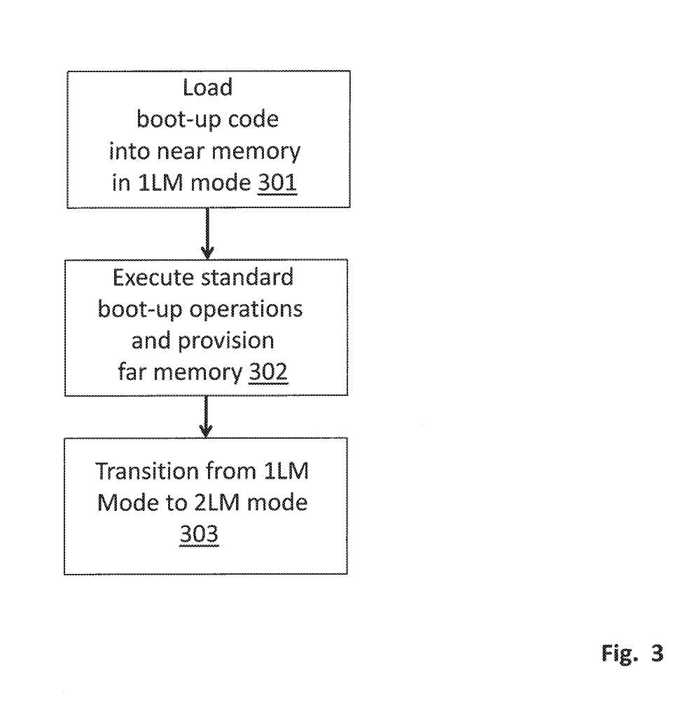

FIG. 3 shows an embodiment of a boot-up sequence for a multi-level computing system that first wakes up in a 1LM mode and then seamlessly transitions into a 2LM mode. As observed in FIG. 3, the system loads boot-up code and data. With the system being designed to initially operate in 1LM mode, the boot-up code will be placed by the memory controller into near memory 301. As described above, the footprint of the boot-up code and data is designed to not exceed the size of the near memory. In various embodiments, the boot up code and data may equally be run, without modification, on a 1LM system or a 2LM system in 2LM mode. The boot-up code then begins operation 302.

During the boot-up sequence 302 standard boot-up operations may be performed (e.g., setting configuration registers within the computing system). Additionally, far memory may be provisioned. In one embodiment, the far memory provisioning code will only take effect if an un-provisioned far memory is encountered (in other cases, it will terminate without effect). As such, the far memory provisioning code may equally be run, without modification, on a 1LM system or a 2LM system in 2LM mode. The provisioning mechanisms, may include separate control buses (such as I2C) to the far memory 302, or may include a special mechanism to allow specified memory transactions to bypass the cache control 221 and be sent, e.g., via FM interface 225, to far memory 214.

In a 2LM system running in 1LM mode, once far memory is provisioned successfully, the system may be ready to transition to 2LM mode 303. The transition to 2LM mode may include setting a control register in the configuration registers 224 of the memory controller 216 to indicate 2LM mode instead of 1LM mode in which case, the activities described in sections 2b, 2c, 2d, 2e, and 2f will cease, and the far memory interface 225 will be accessible.

In various embodiments, the software involvement in switching from 1LM mode to 2LM mode is minimal and self-contained. It would naturally be skipped in a 1LM system or in a 2LM system that could not be switched from 1LM to 2LM mode (say due to errors discovered in far memory 214 during provisioning).

Note that, other than the software specifically assigned the task of switching from 1LM to 2LM mode, in various embodiments, no special software attention needs to be paid to the operating mode. The only differences noticeable to the software between 1LM mode of a 2LM system, 2LM mode, and a true 1LM system relate to the amount of available memory for software operation and speed of memory accesses; in the general case, software is ambivalent to these factors.

As such essentially identical software is able to run irrespective of the operating mode of the system. As such, conceivably, there need not be multiple versions ‘branches’ of the software that require independent development, debugging and maintenance.

Of further note is that, during the process of switching from 1LM to 2LM mode 303, in various embodiments, there is no disruption to memory consistency, as viewed from the CPU. This is advantageous compared to other techniques, such creating a 1LM mode by exposing the near memory 213 as a small main memory to the CPU, in which the system could not quickly be switched from 1LM to 2LM mode, as the contents of data at addresses accessed by the CPU would change. Generally, in such a system, the software flow would be to “reboot into 2LM mode”, and the system would re-boot, running different code according to 2LM operation.

In an alternate embodiment, a 1LM mode is created by initially exposing the near memory 213 as a small main memory to the CPU, and prior to the switch to 2LM mode marking the Metadata for this memory to reflect the system address and that the data was dirty. Such a scheme could avoid the need for dummy FM memory 222, but carries additional considerations (such as marking more memory as dirty than may actually have been accessed).

Maintenance of far memory can also execute a similar process to the process observed in FIG. 3. Here, if a decision is made to maintain system memory by, e.g., replacing far memory chips with new far memory chips, state information of far memory chips needing replacement may be backed-up into, e.g., deeper non volatile storage and the system may be shut down and far memory may be de-activated. The system may then wake-up and follow the process of FIG. 3 except that certain standard boot-up operations may not be performed and the provisioning of the new far memory chips also includes the swapping out of old far memory and the swapping in of the new far memory chips.

Referring back to FIG. 2, note that links 227, 228 may be logical and/or physical links depending on implementation. For example, a far memory controller (not shown) may be located on a far memory DIMM card with far memory chips that the far memory controller is responsible for managing. In this implementation, e.g., memory controller 216 may be an integrated host side memory controller and link 228 may be a memory channel that emanates from the host side memory controller. In the same embodiment, near memory DIMM cards (having, e.g., DRAM memory chips) may or may not plug into the same memory channel that the aforementioned far memory DIMM card plugs into.

In the case of the latter (a near memory DIMM does not plug into the same memory channel as a far memory DIMM), link 227 is a different physical link than either of link 228. In the case of the former (near memory DIMM plugs into the same memory channel as the far memory DIMM), links 227 and 228 correspond to a same physical memory channel but potentially different logical channels. For example, near memory DIMMs may be communicated to through a standard DDR channel while the far memory controller is communicated with over the same physical DDR channel (and therefore uses many of the same signals as the near memory communication) but that additionally executes a transactional protocol over the DDR channel.

In yet alternate or combined embodiments, the near memory DRAM memory chips may be located on the same DIMM card as the far memory controller and the far memory chips. In this case, again links 227, 228 may correspond to a same physical channel but different logical channels where the physical channel is directed to a same DIMM card rather than different DIMM cards.

Various functions of the memory controller 216 may alternatively be integrated on a DIMM card having near memory and/or far memory chips. For example, a DIMM card having both near memory and far memory chips may have a memory control function (e.g., integrated with the aforementioned far memory controller) that includes all of the memory controller components observed in FIG. 2. In this, links 227, 228 correspond to local memory channels on the DIMM card and link 229 corresponds to the memory channel that the DIMM card is plugged into. Here, each such DIMM card will have its own memory controller 216 function.

In yet other embodiments, different packaging arrangements than those described just above may be implemented but the same over-arching principles still apply. For example, in one embodiment the near memory devices may be packaged in a same processor package that includes the processor(s) and integrated memory controller (e.g., by stacking the memory chips over a system-on-chip die that includes the processor(s) and integrated memory controller) while the far memory devices may be packaged externally from the processor package. In this case, link 227 is an internal link within the processor package and link 228 is an external link that emanates from the processor package.

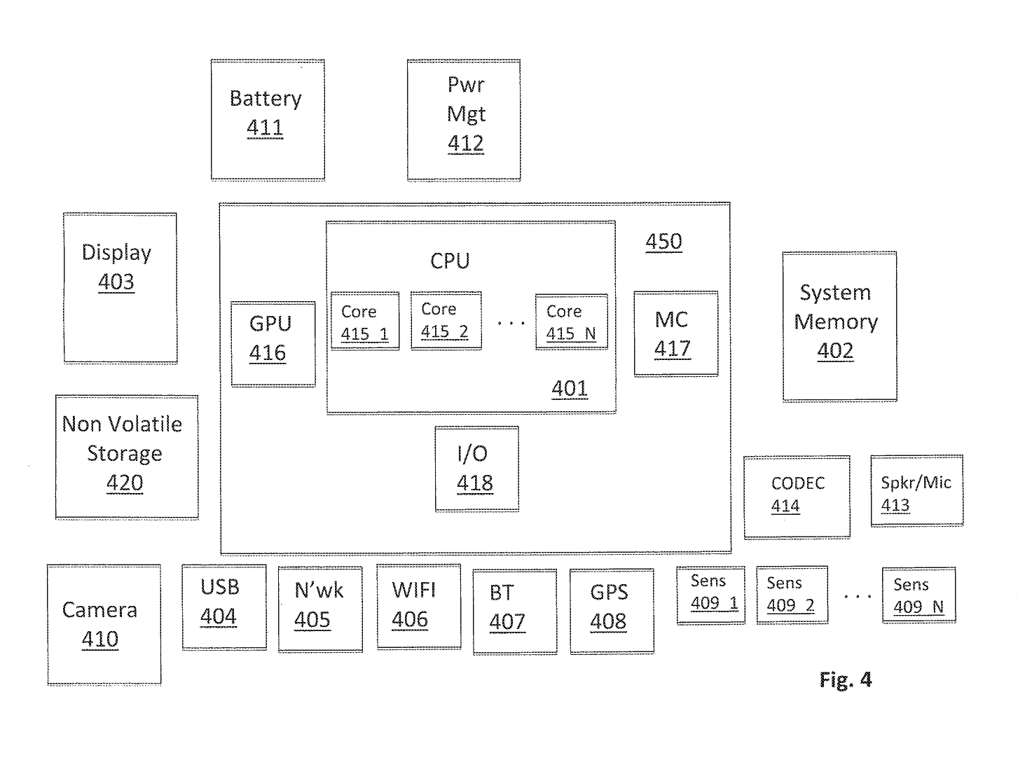

FIG. 4 shows a depiction of an exemplary computing system 400 such as a personal computing system (e.g., desktop or laptop) or a mobile or handheld computing system such as a tablet device or smartphone, or, a larger computing system such as a server computing system. As observed in FIG. 4, the basic computing system may include a central processing unit 401 (which may include, e.g., a plurality of general purpose processing cores and a main memory controller disposed on an applications processor or multi-core processor), system memory 402, a display 403 (e.g., touchscreen, flat-panel), a local wired point-to-point link (e.g., USB) interface 04, various network I/O functions 405 (such as an Ethernet interface and/or cellular modem subsystem), a wireless local area network (e.g., WiFi) interface 406, a wireless point-to-point link (e.g., Bluetooth) interface 407 and a Global Positioning System interface 408, various sensors 409_1 through 409_N (e.g., one or more of a gyroscope, an accelerometer, a magnetometer, a temperature sensor, a pressure sensor, a humidity sensor, etc.), a camera 410, a battery 411, a power management control unit 412, a speaker and microphone 413 and an audio coder/decoder 414.

An applications processor or multi-core processor 450 may include one or more general purpose processing cores 415 within its CPU 401, one or more graphical processing units 416, a memory management function 417 (e.g., a memory controller) and an I/O control function 418. The general purpose processing cores 415 typically execute the operating system and application software of the computing system. The graphics processing units 416 typically execute graphics intensive functions to, e.g., generate graphics information that is presented on the display 403. The memory control function 417 interfaces with the system memory 402. The system memory 402 may be a multi-level system memory such as the multi-level system memory discussed at length above. The system memory may include a memory controller that supports 1LM and 2LM modes of operation as discussed above.

Each of the touchscreen display 403, the communication interfaces 404-407, the GPS interface 408, the sensors 409, the camera 410, and the speaker/microphone codec 413, 414 all can be viewed as various forms of I/O (input and/or output) relative to the overall computing system including, where appropriate, an integrated peripheral device as well (e.g., the camera 410). Depending on implementation, various ones of these I/O components may be integrated on the applications processor/multi-core processor 450 or may be located off the die or outside the package of the applications processor/multi-core processor 450.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of software or instruction programmed computer components or custom hardware components, such as application specific integrated circuits (ASIC), programmable logic devices (PLD), digital signal processors (DSP), or field programmable gate array (FPGA).

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. At least one machine readable storage medium containing program code that when processed by a computing system having a multi-level system memory causes a method to be performed, the method comprising:
in a computing system having a multi-level system memory:
executing code from a higher level of the multi-level system memory in a first mode in which a lower level of the system memory is not available; and,
transitioning to a second mode in which the lower level of the system memory is available.

2. The machine readable storage medium of claim 1 wherein the first mode is a 1LM mode and the second mode is a 2LM mode.

3. The machine readable storage medium of claim 1 wherein the size of the code does not exceed the size of the higher level of the system memory.

4. The machine readable storage medium of claim 1 wherein the executing of the code includes provisioning the lower level of the system memory where the provisioning is a pre-condition to the transitioning.

5. The machine readable storage medium of claim 1 wherein the code is boot-up code and a storage capacity of the higher level of the multi-level system memory is sufficient to store the boot-up code.

6. The machine readable storage medium of claim 1 wherein the method further comprises setting register space of a memory controller that interfaces to the higher and lower levels of system memory to indicate system state in the first mode.

7. The machine readable storage medium of claim 6 wherein the transitioning includes setting the register space to indicate system state in the second mode.

8. The machine readable storage medium of claim 1 wherein the higher level of the multi-level system memory comprises a cache and a memory controller that interfaces to the higher level of system memory is to raise an error upon a cache miss resulting in a dirty eviction in the first mode.

9. The machine readable storage medium of claim 1 wherein the higher level of the multi-level system memory comprises a cache and a memory controller that interfaces to the higher level of system memory is to suspend scrubbing of the cache in the first mode.

10. The machine readable storage medium of claim 1 wherein the higher level of the multi-level system memory comprises a cache and a memory controller that interfaces to the higher level of system memory is to mark read data as dirty in the first mode.

11. The machine readable storage medium of claim 10 wherein the method further comprises evicting the read data marked as dirty after the transitioning to the second mode even though the read data was never written to in the first mode.

12. The machine readable storage medium of claim 1 wherein the higher level of the multi-level system memory comprises a cache and a memory controller that interfaces to the higher level of system memory is to, during the first mode, internally provide a return value for an access that would otherwise be directed to the lower level of system memory during the second mode.

13. The machine readable storage medium of claim 1 wherein the higher level of the multi-level system memory comprises a cache and a memory controller that interfaces to the higher level of system memory is to, during the first mode, initially declare data in the higher level memory as valid.

14. The machine readable storage medium of claim 1 wherein the code executes continuously from the first mode and the second mode.

15. An apparatus, comprising:
a memory controller to interface to a multi-level system memory having a higher level and a lower level, said memory controller comprising register space to indicate:
a first mode of operation in which said higher level is available and said lower level is unavailable;
a second mode of operation in which said higher level is available and said lower level is available.

16. The apparatus of claim 15 wherein said higher level of the multi-level system memory comprises a cache and said memory controller is to raise an error upon a cache miss resulting in a dirty eviction in the first mode.

17. The apparatus of claim 15 wherein said higher level of the multi-level system memory comprises a cache and said memory controller is to suspend scrubbing of the cache in the first mode.

18. The apparatus of claim 15 wherein said higher level of the multi-level system memory comprises a cache and said memory controller is to mark read data as dirty in the first mode.

19. The apparatus of claim 15 wherein said higher level of the multi-level system memory comprises a cache and said memory controller is to internally provide a return value for an access that would otherwise be directed to the lower level of system memory.

20. The apparatus of claim 15 wherein said higher level of the multi-level system memory comprises a cache and said memory controller is to initially declare data in the higher level memory as valid.

21. A computing system, comprising:
a) a plurality of processing cores;
b) a multi-level system memory comprising a higher level and a lower level;
c) a memory controller to interface to the multi-level system memory, the memory controller comprising register space to indicate:
a first mode of operation in which said higher level is available and said lower level is unavailable;
a second mode of operation in which said higher level is available and said lower level is available; and,
d) a networking interface.

22. The computing system of claim 21 wherein said higher level of the multi-level system memory comprises a cache and said memory controller is to raise an error upon a cache miss resulting in a dirty eviction in the first mode.

23. The computing system of claim 21 wherein said higher level of the multi-level system memory comprises a cache and said memory controller is to suspend scrubbing of the cache in the first mode.

24. The computing system of claim 21 wherein said higher level of the multi-level system memory comprises a cache and said memory controller is to mark read data as dirty in the first mode.

25. The computing system of claim 21 wherein said higher level of the multi-level system memory comprises a cache and said memory controller is to internally provide a return value for an access that would otherwise be directed to the lower level of system memory.

26. The computing system of claim 21 wherein said higher level of the multi-level system memory comprises a cache and said memory controller is to initially declare data in the higher level memory as valid.

27. The computing system of claim 21 wherein the lower level of system memory comprises a three-dimensional cross point non volatile memory.

28. The computing system of claim 21 wherein the lower level of system memory is comprises any of:
a phase change memory;
a ferro-electric random access memory;
a magnetic random access memory;
a spin transfer torque random access memory;
a resistor random access memory;
a memristor memory;
a universal memory;
a Ge2Sb2Te5 memory;
a programmable metallization cell memory;
an amorphous cell memory; and/or
an Ovshinsky memory.
